(19) United States
(12) Patent Application Publication
(10) Pub. No.: US 2022/0351631 A1
(43) Pub. Date: Nov. 3, 2022

(54) UNMANNED AERIAL VEHICLE RESPONSE TO OBJECT DETECTION

(71) Applicant: SKYGRID, LLC, AUSTIN, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US); TAYLOR R. SCHMIDT, AUSTIN, TX (US); MILTON LOPEZ, ROUND ROCK, TX (US); RAVI TEJA PINNAMANENI, AUSTIN, TX (US)

(21) Appl. No.: 17/727,713

(22) Filed: Apr. 23, 2022

Related U.S. Application Data
(60) Provisional application No. 63/181,259, filed on Apr. 29, 2021.

(51) Int. Cl. G08G 5/00; B64C 39/02

(52) U.S. Cl. CPC G08G 5/0069; G08G 5/0013; B64C 39/024; B64C 2201/12

(57) ABSTRACT

Methods, apparatuses, system, devices, and computer program products for unmanned aerial vehicle (UAV) response to object detection are disclosed. In a particular embodiment, a detection response controller receives data generated by one or more sensors of a UAV. Based on the generated data, the detection response controller determines a presence and an identification of an object in a proximity of the UAV. Based on the presence and the identification of the object, the detection response controller determines one or more actions for the UAV to perform.

### CROSS-REFERENCE TO RELATED APPLICATIONS

This application is a non-provisional application for patent entitled to a filing date and claiming the benefit of earlier-filed U.S. Provisional Patent Application Ser. No. 63/181,259, filed Apr. 29, 2021, the contents of which are incorporated by reference herein in their entirety.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under 400 feet above ground level (AGL)) in airspace where FAA air traffic services are not provided. However, a framework that extends beyond the 400 feet AGL limit is needed. For example, unmanned aircraft that would be used by package delivery services and air taxis may need to travel at altitudes above 400 feet. Such a framework requires technology that will allow the FAA to safely regulate unmanned aircraft.

### SUMMARY

Methods, apparatuses, system, devices, and computer program products for unmanned aerial vehicle (UAV) response to object detection are disclosed. In a particular embodiment, a detection response controller receives data generated by one or more sensors of a UAV. Based on the generated data, the detection response controller determines a presence and an identification of an object in a proximity of the UAV. Based on the presence and the identification of the object, the detection response controller determines one or more actions for the UAV to perform.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating a particular implementation of a system for unmanned aerial vehicle response to object detection;

FIG. 2 sets forth a block diagram illustrating another implementation of a system for unmanned aerial vehicle response to object detection;

FIG. 3A sets forth a block diagram illustrating a particular implementation of the blockchain used by the systems of FIGS. 1-2 to record data associated with an unmanned aerial vehicle;

FIG. 3B sets forth an additional view of the blockchain of FIG. 3A;

FIG. 3C sets forth an additional view of the blockchain of FIG. 3A;

FIG. 4 is a flowchart to illustrate an implementation of a method for unmanned aerial vehicle response to object detection;

FIG. 5 is a flowchart to illustrate another implementation of a method for unmanned aerial vehicle response to object detection;

FIG. 6 is a flowchart to illustrate another implementation of a method for unmanned aerial vehicle response to object detection;

FIG. 7 is a flowchart to illustrate another implementation of a method for unmanned aerial vehicle response to object detection;

FIG. 8 is a flowchart to illustrate another implementation of a method for unmanned aerial vehicle response to object detection;

FIG. 9 is a flowchart to illustrate another implementation of a method for unmanned aerial vehicle response to object detection;

FIG. 10 is a flowchart to illustrate another implementation of a method for unmanned aerial vehicle response to object detection; and

FIG. 11 is a flowchart to illustrate another implementation of a method for unmanned aerial vehicle response to object detection.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

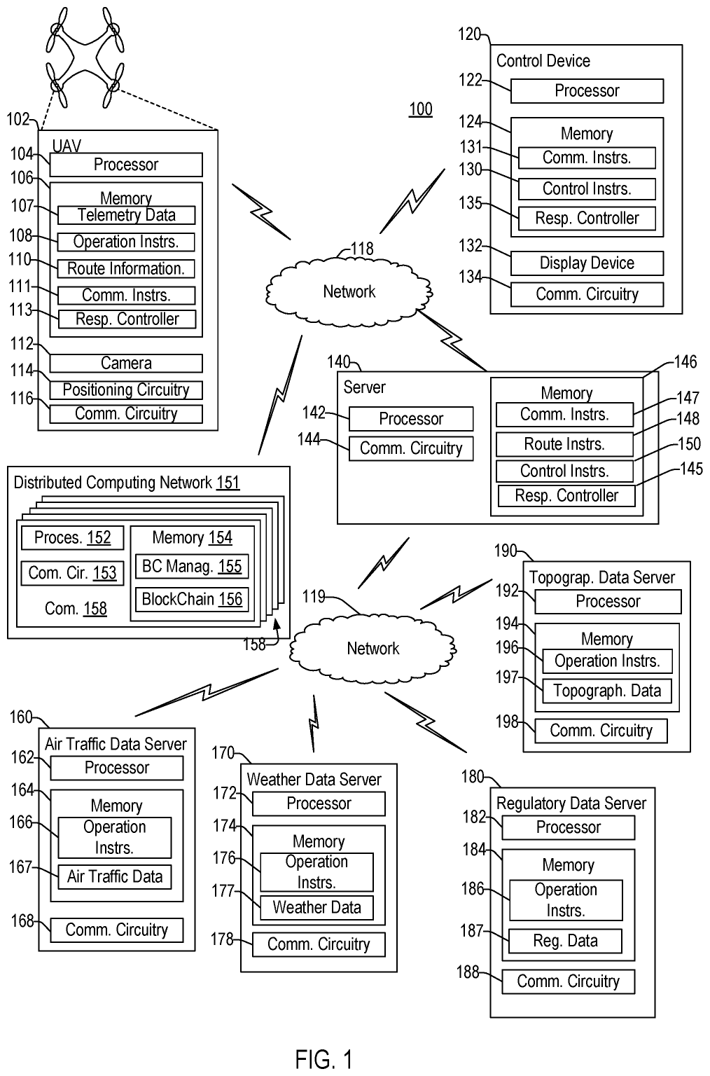

Exemplary methods, apparatuses, and computer program products for unmanned aerial vehicle response to object detection in accordance with the present invention are described with reference to the accompanying drawings, beginning with FIG. 1. FIG. 1 sets forth a diagram of a system 100 for unmanned aerial vehicle response to object detection according to embodiments of the present disclosure. The system 100 of FIG. 1 includes an unmanned aerial vehicle (UAV) 102, a control device 120, a server 140, a distributed computing network 151, an air traffic data server 160, a weather data server 170, a regulatory data server 180, and a topographical data server 190.

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such as passenger drones drone taxi, flying taxi, or pilotless helicopter carry human passengers.

For ease of illustration, the UAV 102 is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV 102 includes a processor 104 coupled to a memory 106, a camera 112, positioning circuitry 114, and communication circuitry 116. The communication circuitry 116 includes a transmitter and a receiver or a combination thereof (e.g., a transceiver). In a particular implementation, the communication circuitry 116 (or the processor 104) is configured to encrypt outgoing message(s) using a private key associated with the UAV 102 and to decrypt incoming message(s) using a public key of a device (e.g., the control device 120 or the server 140) that sent the incoming message(s). As will be explained further below, the outgoing and incoming messages may be transaction messages that include information associated with the UAV. Thus, in this implementation, communications between the UAV 102, the control device 120, and the server 140 are secure and trustworthy (e.g., authenticated).

The camera 112 is configured to capture image(s), video, or both, and can be used as part of a computer vision system. For example, the camera 112 may capture images or video and provide the video or images to a pilot of the UAV 102 to aid with navigation. Additionally, or alternatively, the camera 112 may be configured to capture images or video to be used by the processor 104 during performance of one or more operations, such as a landing operation, a takeoff operation, or object/collision avoidance, as non-limiting examples. Although a single camera 112 is shown in FIG. 1, in alternative implementations more and/or different sensors may be used (e.g., infrared, LIDAR, SONAR, etc.).

The positioning circuitry 114 is configured to determine a position of the UAV 102 before, during, and/or after flight. For example, the positioning circuitry 114 may include a global positioning system (GPS) interface or sensor that determines GPS coordinates of the UAV 102. The positioning circuitry 114 may also include gyroscope(s), accelerometer(s), pressure sensor(s), other sensors, or a combination thereof, that may be used to determine the position of the UAV 102.

The processor 104 is configured to execute instructions stored in and retrieved from the memory 106 to perform various operations. For example, the instructions include operation instructions 108 that include instructions or code that cause the UAV 102 to perform flight control operations. The flight control operations may include any operations associated with causing the UAV to fly from an origin to a destination. For example, the flight control operations may include operations to cause the UAV to fly along a designated route (e.g., based on route information 110, as further described herein), to perform operations based on control data received from one or more control devices, to take off, land, hover, change altitude, change pitch/yaw/roll angles, or any other flight-related operations. The UAV 102 may include one or more actuators, such as one or more flight control actuators, one or more thrust actuators, etc., and execution of the operation instructions 108 may cause the processor 104 to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The route information 110 may indicate a flight path for the UAV 102 to follow. For example, the route information 110 may specify a starting point (e.g., an origin) and an ending point (e.g., a destination) for the UAV 102. Additionally, the route information may also indicate a plurality of waypoints, zones, areas, regions between the starting point and the ending point.

The route information 110 may also indicate a corresponding set of control devices for various points, zones, regions, areas of the flight path. The indicated sets of control devices may be associated with a pilot (and optionally one or more backup pilots) assigned to have control over the UAV 102 while the UAV 102 is in each zone. The route information 110 may also indicate time periods during which the UAV is scheduled to be in each of the zones (and thus time periods assigned to each pilot or set of pilots).

In the example of FIG. 1, the memory 106 of the UAV 102 also includes communication instructions 111 that when executed by the processor 104 cause the processor 104 to transmit to the distributed computing network 151, transaction messages that include telemetry data 107. Telemetry data may include any information that could be useful to identifying the location of the UAV, the operating parameters of the UAV, or the status of the UAV. Examples of telemetry data include but are not limited to GPS coordinates, instrument readings (e.g., airspeed, altitude, altimeter, turn, heading, vertical speed, attitude, turn and slip), and operational readings (e.g., pressure gauge, fuel gauge, battery level).

In the example of FIG. 1, the memory 106 of the UAV 102 also includes detection response controller 113 that when executed by the processor 104 cause the processor 104 to perform operations directed to UAV response to object detection, according to at least one embodiment of the present disclosure. In a particular embodiment, the detection response controller 113 cause the processor 104 to carry out the operations of: receiving, by a detection response controller, data generated by one or more sensors of a UAV; determining based on the generated data, by the detection response controller, a presence and an identification of an object in a proximity of the UAV; and determining based on the presence and the identification of the object, by the detection response controller, one or more actions for the UAV to perform.

Alternatively, a remote computing device may perform the object detection based on images from the UAV; identify the actions for the UAV to perform in response to detecting a particular object; and instruct the UAV to perform the identified actions. For example, in another embodiment, the detection response controller 113 cause the processor 104 to provide images captured by the camera 112 to a computing device (e.g., the control device 120; the server 140); receive from the computing device, an instruction to perform one or more actions; and perform the one or more actions.

The control device 120 includes a processor 122 coupled to a memory 124, a display device 132, and communication circuitry 134. The display device 132 may be a liquid crystal display (LCD) screen, a touch screen, another type of display device, or a combination thereof. The communication circuitry 134 includes a transmitter and a receiver or a combination thereof (e.g., a transceiver). In a particular implementation, the communication circuitry 134 (or the processor 122 is configured to encrypt outgoing message(s) using a private key associated with the control device 120 and to decrypt incoming message(s) using a public key of a device (e.g., the UAV 102 or the server 140 that sent the incoming message(s). Thus, in this implementation, communication between the UAV 102, the control device 120, and the server 140 are secure and trustworthy (e.g., authenticated).

The processor 122 is configured to execute instructions from the memory 124 to perform various operations. The instructions also include control instructions 130 that include instructions or code that cause the control device 120 to generate control data to transmit to the UAV 102 to enable the control device 120 to control one or more operations of the UAV 102 during a particular time period, as further described herein.

In the example of FIG. 1, the memory 124 of the control device 120 also includes communication instructions 131 that when executed by the processor 122 cause the processor 122 to transmit to the distributed computing network 151, transaction messages that include control instructions 130 that are directed to the UAV 102. In a particular embodiment, the transaction messages are also transmitted to the UAV and the UAV takes action (e.g., adjusting flight operations), based on the information (e.g., control data) in the message.

In the example of FIG. 1, the memory 124 of the control device 120 also includes detection response controller 135 that when executed by the processor 122 cause the processor 122 to perform operations directed to UAV response to object detection, according to at least one embodiment of the present disclosure. In a particular embodiment, the detection response controller 135 cause the processor 122 to carry out the operations of: receiving, by a detection response controller, data generated by one or more sensors of a UAV; determining based on the generated data, by the detection response controller, a presence and an identification of an object in a proximity of the UAV; and determining based on the presence and the identification of the object, by the detection response controller, one or more actions for the UAV to perform.

The server 140 includes a processor 142 coupled to a memory 146, and communication circuitry 144. The communication circuitry 144 includes a transmitter and a receiver or a combination thereof (e.g., a transceiver). In a particular implementation, the communication circuitry 144 (or the processor 142) is configured to encrypt outgoing message(s) using a private key associated with the server 140 and to decrypt incoming message(s) using a public key of a device (e.g., the UAV 102 or the control device 120) that sent the incoming message(s). As will be explained further below, the outgoing and incoming messages may be transaction messages that include information associated with the UAV. Thus, in this implementation, communication between the UAV 102, the control device 120, and the server 140 are secure and trustworthy (e.g., authenticated).

The processor 142 is configured to execute instructions from the memory 146 to perform various operations. The instructions include route instructions 148 comprising computer program instructions for aggregating data from disparate data servers, virtualizing the data in a map, generating a cost model for paths traversed in the map, and autonomously selecting the optimal route for the UAV based on the cost model. For example, the route instructions 148 are configure to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions 148 are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions 148 may also include instructions for storing the parameters of the selected optimal flight path as route information 110. For example, the route information may include waypoints marked by GPS coordinates, arrival times for waypoints, pilot assignments. The route instructions 148 may also include instructions receiving, by a server in a UAV transportation ecosystem, disinfection area data; accessing, by the server, UAV parameters for a type of UAV; determining, by the server in dependence upon the disinfection area data and the UAV parameters, a number of UAVs needed to complete a coordinated aerial disinfection of a disinfection area within a time limit; and partitioning, by the server, the disinfection area into a plurality of partitions, wherein the number of partitions is equal to the number of UAVs. The server 140 may be configured to transmit the route information 110, including disinfection route information, to the UAV 102.

The instructions may also include control instructions 150 that include instructions or code that cause the server 140 to generate control data to transmit to the UAV 102 to enable the server 140 to control one or more operations of the UAV 102 during a particular time period, as further described herein.

In the example of FIG. 1, the memory 146 of the server 140 also includes detection response controller 145 that when executed by the processor 142 cause the processor 142 to perform operations directed to UAV response to object detection, according to at least one embodiment of the present disclosure. In a particular embodiment, the detection response controller 145 cause the processor 142 to carry out the operations of: receiving, by a detection response controller, data generated by one or more sensors of a UAV; determining based on the generated data, by the detection response controller, a presence and an identification of an object in a proximity of the UAV; and determining based on the presence and the identification of the object, by the detection response controller, one or more actions for the UAV to perform.

In the example of FIG. 1, the memory 146 of the server 140 also includes communication instructions 147 that when executed by the processor 142 cause the processor 142 to transmit to the distributed computing network 151, transaction messages that include control instructions 150 or route instructions 148 that are directed to the UAV 102.

The distributed computing network 151 of FIG. 1 includes a plurality of computers 157. An example computer 158 of the plurality of computers 157 is shown and includes a processor 152 coupled to a memory 154, and communication circuitry 153. The communication circuitry 153 includes a transmitter and a receiver or a combination thereof (e.g., a transceiver). In a particular implementation, the communication circuitry 153 (or the processor 152) is configured to encrypt outgoing message(s) using a private key associated with the computer 158 and to decrypt incoming message(s) using a public key of a device (e.g., the UAV 102, the control device 120, or the server 140) that sent the incoming message(s). As will be explained further below, the outgoing and incoming messages may be transaction messages that include information associated with the UAV. Thus, in this implementation, communication between the UAV 102, the control device 120, the server 140, and the distributed computing network 151 are secure and trustworthy (e.g., authenticated).

The processor 142 is configured to execute instructions from the memory 154 to perform various operations. The memory 154 includes a blockchain manager 155 that includes computer program instructions for operating an UAV. Specifically, the blockchain manager 155 includes computer program instructions that when executed by the processor 152 cause the processor 152 to receive a transaction message associated with a UAV. For example, the blockchain manager may receive transaction messages from the UAV 102, the control device 120, or the server 140. The blockchain manager 155 also includes computer program instructions that when executed by the processor 152 cause the processor 152 to use the information within the transaction message to create a block of data; and store the created block of data in a blockchain data structure 156 associated with the UAV.

The blockchain manager may also include instructions for accessing information regarding an unmanned aerial vehicle (UAV). For example, the blockchain manager 155 also includes computer program instructions that when executed by the processor 152 cause the processor to receive from a device, a request for information regarding the UAV; in response to receiving the request, retrieve from a blockchain data structure associated with the UAV, data associated with the information requested; and based on the retrieved data, respond to the device.

The UAV 102, the control device 120, and server 140 are communicatively coupled via a network 118. For example, the network 118 may include a satellite network or another type of network that enables wireless communication between the UAV 102, the control device 120, the server 140, and the distributed computing network 151. In an alternative implementation, the control device 120 and the server 140 communicate with the UAV 102 via separate networks (e.g., separate short range networks).

In some situations, minimal (or no) manual control of the UAV 102 may be performed, and the UAV 102 may travel from the origin to the destination without incident. However, in some situations, one or more pilots may control the UAV 102 during a time period, such as to perform object avoidance or to compensate for an improper UAV operation. In some situations, the UAV 102 may be temporarily stopped, such as during an emergency condition, for recharging, for refueling, to avoid adverse weather conditions, responsive to one or more status indicators from the UAV 102, etc. In some implementations, due to the unscheduled stop, the route information 110 may be updated (e.g., via a subsequent blockchain entry, as further described herein) by route instructions 148 executing on the UAV 102, the control device 120, or the server 140). The updated route information may include updated waypoints, updated time periods, and updated pilot assignments.

In a particular implementation, the route information is exchanged using a blockchain data structure. The blockchain data structure may be shared in a distributed manner across a plurality of devices of the system 100, such as the UAV 102, the control device 120, the server 140, and any other control devices or UAVs in the system 100. In a particular implementation, each of the devices of the system 100 stores an instance of the blockchain data structure in a local memory of the respective device. In other implementations, each of the devices of the system 100 stores a portion of the shared blockchain data structure and each portion is replicated across multiple of the devices of the system 100 in a manner that maintains security of the shared blockchain data structure as a public (i.e., available to other devices) and incorruptible (or tamper evident) ledger. Alternatively, as in FIG. 1, the blockchain 156 is stored in a distributed manner in the distributed computing network 151.

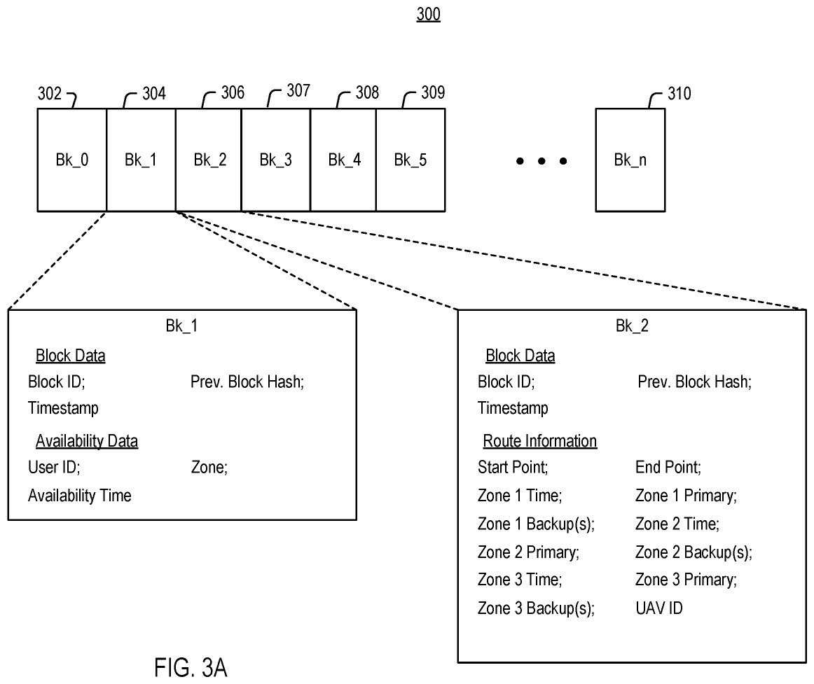

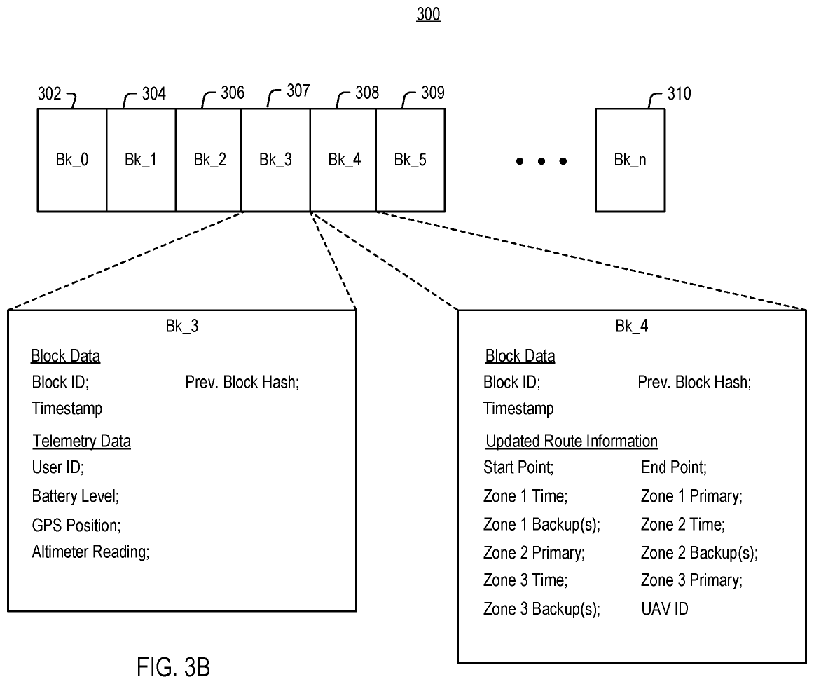

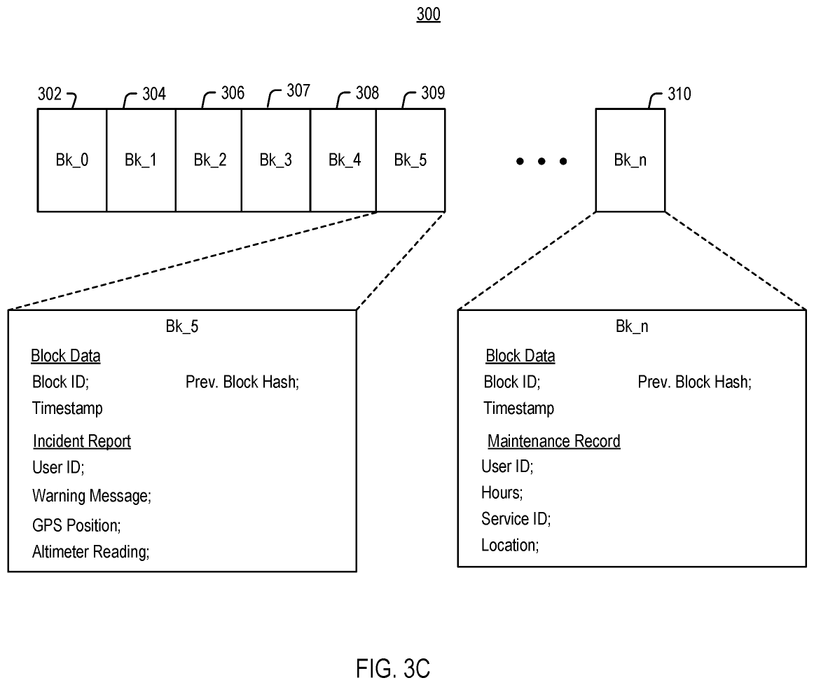

The blockchain data structure 156 may include, among other things, route information associated with the UAV 102, the telemetry data 107, the control instructions 130; and the route instructions 148. For example, the route information 110 may be used to generate blocks of the blockchain data structure 156. A sample blockchain data structure 300 is illustrated in FIGS. 3A-3C. Each block of the blockchain data structure 300 includes block data and other data, such as availability data, route data, telemetry data, service information, incident reports, etc.

The block data of each block includes information that identifies the block (e.g., a block ID) and enables the devices of the system 100) to confirm the integrity of the blockchain data structure 300. For example, the block data also includes a timestamp and a previous block hash. The timestamp indicates a time that the block was created. The block ID may include or correspond to a result of a hash function (e.g., a SHA256 hash function, a RIPEMD hash function, etc.) based on the other information (e.g., the availability data or the route data) in the block and the previous block hash (e.g., the block ID of the previous block). For example, in FIG. 3A, the blockchain data structure 300 includes an initial block (Bk_0) 302 and several subsequent blocks, including a block Bk_1 304, a block Bk_2 306, a block BK_3 307, a block BK_4 308, a block BK_5 309, and a block Bk_n 310. The initial block Bk_0 302 includes an initial set of availability data or route data, a timestamp, and a hash value (e.g., a block ID) based on the initial set of availability data or route data. As shown in FIG. 1, the block Bk_1 304 also may include a hash value based on the other data of the block Bk_1 304 and the previous hash value from the initial block Bk_0 302. Similarly, the block Bk_2 306 other data and a hash value based on the other data of the block Bk_2 306 and the previous hash value from the block Bk_1 304. The block Bk_n 310 includes other data and a hash value based on the other data of the block Bk_n 310 and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system 100.

In addition to the block data, each block of the blockchain data structure 300 includes some information associated with a UAV (e.g., availability data, route information, telemetry data, incident reports, updated route information, maintenance records, etc.). For example, the block Bk_1 304 includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_2 306 includes route information that includes a UAV ID, a start point, an end point, waypoints, GPS coordinates, zone markings, time periods, primary pilot assignments, and backup pilot assignments for each zone associated with the route.

In the example of FIG. 3B, the block BK_3 307 includes telemetry data, such as a user ID (e.g., an identifier of the UAV that generated the telemetry data), a battery level of the UAV; a GPS position of the UAV; and an altimeter reading. As explained in FIG. 1, a UAV may include many types of information within the telemetry data that is transmitted to the blockchain managers of the computers within the distributed computing network 151. In a particular embodiment, the UAV is configured to periodically broadcast to the network 118, a transaction message that includes the UAV's current telemetry data. The blockchain managers of the distributed computing network receive the transaction message containing the telemetry data and store the telemetry data within the blockchain 156.

FIG. 3B also depicts the block BK_4 308 as including updated route information having a start point, an endpoint, and a plurality of zone times and backups, along with a UAV ID. In a particular embodiment, the control device 120 or the server 140 may determine that the route of the UAV should be changed. For example, the control device or the server may detect that the route of the UAV conflicts with a route of another UAV or a developing weather pattern. As another example, the control device or the server many determine that the priority level or concerns of the user have changed and thus the route needs to be changed. In such instances, the control device or the server may transmit to the UAV, updated route information, control data, or navigation information. Transmitting the updated route information, control data, or navigation information to the UAV may include broadcasting a transaction message that includes the updated route information, control data, or navigation information to the network 118. The blockchain manager 155 in the distributed computing network 151, retrieves the transaction message from the network 118 and stores the information within the transaction message in the blockchain 156.

FIG. 3C depicts the block BK_5 309 as including data describing an incident report. In the example of FIG. 3C, the incident report includes a user ID; a warning message; a GPS position; and an altimeter reading. In a particular embodiment, a UAV may transmit a transaction message that includes an incident report in response to the UAV experiencing an incident. For example, if during a flight mission, one of the UAV's propellers failed, a warning message describing the problem may be generated and transmitted as a transaction message.

FIG. 3C also depicts the block BK_n 310 that includes a maintenance record having a user ID of the service provider that serviced the UAV; flight hours that the UAV had flown when the service was performed; the service ID that indicates the type of service that was performed; and the location that the service was performed. UAV must be serviced periodically. When the UAV is serviced, the service provider may broadcast to the blockchain managers in the distributed computing network, a transaction message that includes service information, such as a maintenance record. Blockchain managers may receive the messages that include the maintenance record and store the information in the blockchain data structure. By storing the maintenance record in the blockchain data structure, a digital and immutable record or logbook of the UAV may be created. This type of record or logbook may be particularly useful to a regulatory agency and an owner/operator of the UAV.

Referring back to FIG. 1, in a particular embodiment, the server 140 includes software that is configured to receive telemetry information from an airborne UAV and track the UAV's progress and status. The server 140 is also configured to transmit in-flight commands to the UAV. Operation of the control device and the server may be carried out by some combination of a human operator and autonomous software (e.g., artificial intelligence (AI) software that is able to perform some or all of the operational functions of a typical human operator pilot).

In a particular embodiment, the route instructions 148 cause the server 140 to plan a flight path, generate route information, dynamically reroute the flight path and update the route information based on data aggregated from a plurality of data servers. For example, the server 140 may receive air traffic data 167 over the network 119 from the air traffic data server 160, weather data 177 from the weather data server 170, regulatory data 187 from the regulatory data server 180, and topographical data 197 from the topographic data server 190. It will be recognized by those of skill in the art that other data servers useful in-flight path planning of a UAV may also provide data to the server 140 over the network 101 or through direct communication with the server 140.

The air traffic data server 160 may include a processor 162, memory 164, and communication circuitry 168. The memory 164 of the air traffic data server 160 may include operating instructions 166 that when executed by the processor 162 cause the processor to provide the air traffic data 167 about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server 170 may include a processor 172, memory 174, and communication circuitry 178. The memory 174 of the weather data server 170 may include operating instructions 176 that when executed by the processor 172 cause the processor to provide the weather data 177 that indicates information about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server 180 may include a processor 182, memory 184, and communication circuitry 188. The memory 184 of the weather data server 180 may include operating instructions 186 that when executed by the processor 182 cause the processor to provide the regulatory data 187 that indicates information about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographical data server 190 may include a processor 192, memory 194, and communication circuitry 198. The memory 194 of the topographical data server 190 may include operating instructions 196 that when executed by the processor 192 cause the processor to provide the topographical data that indicates information about terrain, places, structures, transportation, boundaries, hydrography, orthoimagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server 140 may aggregate data from the data servers 160, 170, 180, 190 using application program interfaces (APIs), syndicated feeds and eXtensible Markup Language (XML), natural language processing, JavaScript Object Notation (JSON) servers, or combinations thereof. Updated data may be pushed to the server 140 or may be pulled on-demand by the server 140. Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, orthoimagery, land cover, and elevation. Readers of skill in the art will appreciate that various governmental and non-governmental entities may act as data servers and provide access to that data using APIs, JSON, XML, and other data formats.

Readers of skill in the art will realize that the server 140 can communicate with a UAV 102 using a variety of methods. For example, the UAV 102 may transmit and receive data using Cellular, 5G, Sub1 GHz, SigFox, WiFi networks, or any other communication means that would occur to one of skill in the art.

The network 119 may comprise one or more Local Area Networks (LANs), Wide Area Networks (WANs), cellular networks, satellite networks, internets, intranets, or other networks and combinations thereof. The network 119 may comprise one or more wired connections, wireless connections, or combinations thereof.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

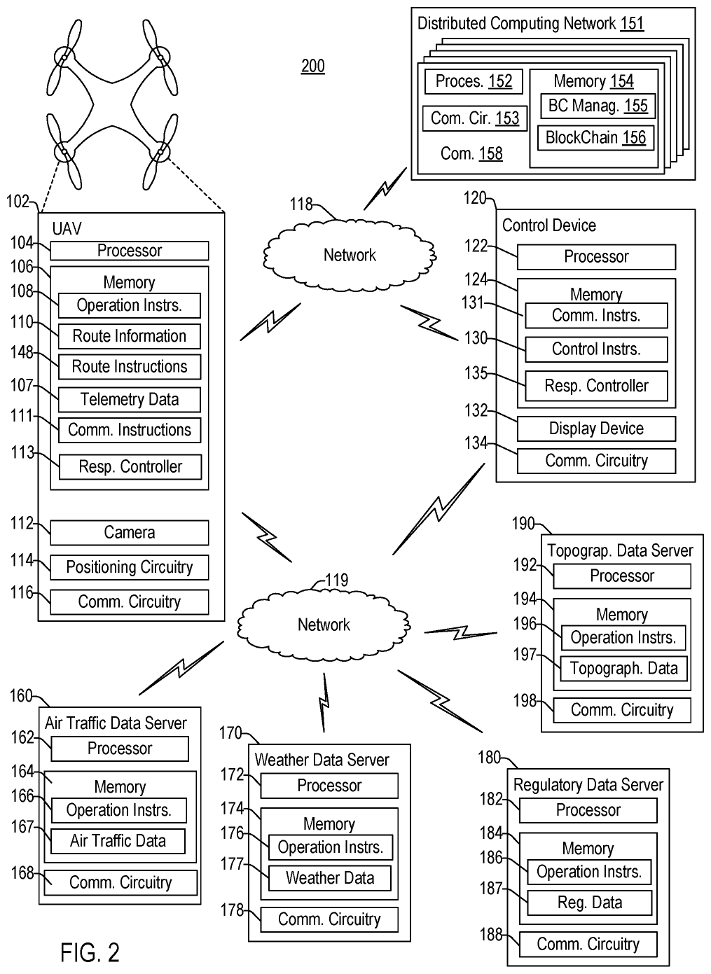

For further explanation, FIG. 2 sets forth a block diagram illustrating another implementation of a system 200 for operating a UAV. Specifically, the system 200 of FIG. 2 shows an alternative configuration in which one or both of the UAV 102 and the server 140 may include route instructions 148 for generating route information. In this example, instead of relying on a server 140 to generate the route information, the UAV 102 and the control device 120 may retrieve and aggregate the information from the various data sources (e.g., the air traffic data server 160, the weather data server 170, the regulatory data server 180, and the topographical data server 190). As explained in FIG. 1, the route instructions may be configured to use the aggregated information from the various source to plan and select a flight path for the UAV 102.

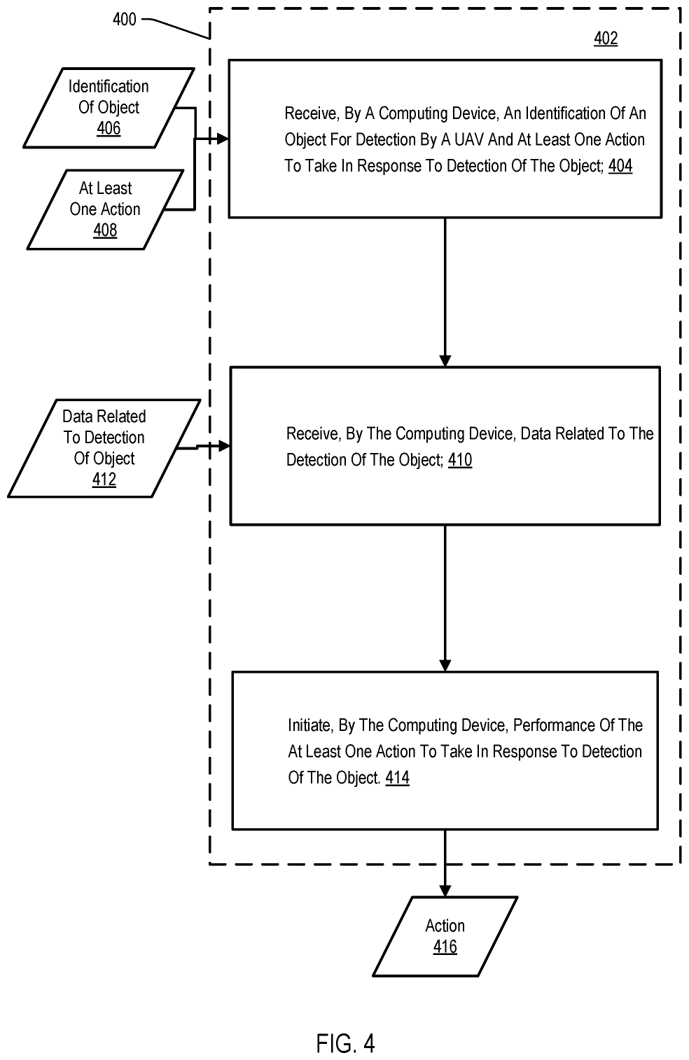

For further explanation, FIG. 4 sets forth a flow chart illustrating an exemplary method 400 for UAV response to object detection in accordance with embodiments of the invention. The method of FIG. 4 is implemented by a computing device 402 that may provide an interface between a UAV user and a UAV. For example, in some embodiments the computing device 402 of FIG. 4 can be the control device 120 of FIGS. 1 and 2, the server 140 of FIGS. 1 and 2, or the distributed computing network 151 of FIGS. 1 and 2. The UAV user can be a UAV pilot or other user of the computing device 402. The UAV can be the UAV 102 of FIGS. 1 and 2.

The computing device 402 can be a computing device that is local to a user, such as control device 120 of FIG. 1, a computing device that is local to a UAV, such as UAV 102 of FIG. 1, or a device that is remote to both the user and the UAV, such as a server 140.

In examples in which the computing device 402 is local to a user, the identification of the object for detection by the UAV and the at least one action to perform may be received by the computing device 402 by way of user interaction with a user interface of the computing device 402. For example, the user interface of the computing device 402 may prompt a user for a description of an object to detect and at least one action to perform when the object is detected. In some examples, the user interface may provide the user with a selection box of options for selecting a description of the object and at least one action to perform.

In examples in which the computing device 402 is local to the UAV, the identification of the object for detection and the at least one action to take may be received by the UAV by way of a communication link such as network 118 of FIG. 1. With reference to FIG. 1, the computing device 402 of the UAV 102 may include communication circuitry 116 communicating with a control device 120 by way of communication circuitry 116 and communication circuitry 134. The control device 120 can send the data 406 representing the identification of the object and the data 408 representing the at least one action to take to the UAV 102 by way of network 118. The computing device 402 of the UAV 102 then receives the data 406 representing the identification of the object and the data 408 representing the at least one action to take from the control device 120 by way of the network 118.

In examples in which the computing device 402 is remote to both a user and the UAV, a remote computing device such as a server 140 of FIG. 1 may receive the data 406 representing the identification of the object to be detected and the data 408 representing at least one action to perform by way of network 118. For example, the server 140 may receive the data 406, 408 from the control device over network 118. In some examples, the method 400 may be implemented by a server 140 as part of a service provided to UAV users. For examples, server 140 may cause a local computing device to display a user interface for interacting with a user. The user may input information identifying an object to be detected and an action to be taken in response to detecting the object by way of the user interface. The server may store the information and initiate performance of the action in response the object being detected.

The method 400 begins with receiving 404 data 406, by the computing device 402, with the data 406 representing an identification of an object for detection by a UAV and receiving 404 data 408 representing at least one action to take in response to detecting the object, receiving 410 data 412 related to the detection of the object, and initiating 414 performance of the at least one action 416 responsive to receiving the data 412 related to the detection of the object. As described previously, the data 406, 408 may be input directly to the computing device 402 by a user, or the data 406, 408 may be received by the computing device over a network.

The object for detection by the UAV can be any object that a user desires to be detected by the UAV. For example, the object can be a person, an animal, a vehicle, a structure, a liquid, a plant, smoke, or a fire. In some examples, the object can detect a general object type such as any person, animal, vehicle, structure, liquid, plant, smoke, or fire, or it can be a specific object limited to a particular set or individual item. For example, the object could be a particular person. In such instances, the object may be identified using techniques such as facial recognition or other identification technique. In other examples, the object to be detected can be a set of persons, such as persons having a particular characteristic. For example, the object to be detected could be people wearing a certain color, people of a certain height, or people matching a certain description. In still other examples, the object to be detected can be limited to an object in a particular location or in association with another object. For example, a UAV inspecting a pipeline may not react to the detection of a liquid unless the liquid is adjacent to a pipeline, or a person may be ignored unless they are within a specific geographic boundary.

The data 406 representing an identification of an object to be detected by the UAV can include information describing the appearance of the object, information describing a characteristic of the object, or a reference to a data store storing information about objects for detection. For example, the information related to the appearance of the object can include information such as color, size, shape, luminosity, or other visual characteristics. In another example, information describing a characteristic can include patterns for recognition such as a bar code or quick response (QR) code, an object temperature, a movement characteristic such as smooth or intermittent, a gait style, object emissions, sound patterns, or other characteristics. In examples including a reference to a data store, the data store can be an information repository storing data including the previously described appearance information and characteristics. The data 406 can further identify a particular sensor or combination of sensors that the UAV can use. For example, the data can include information identifying a camera for a visual identification, a microphone for audio detection, a GPS system for identifying location, and/or a thermal sensor for identifying a temperature.

The data 408 representing at least one action to take in response to detection of the object can comprise any action that a user would like performed in response to the detection of the object. Examples of actions that can be taken in response to detecting an object can include sending an alert, sending a text message, sending an email message, altering a flight plan, increasing a counter, or notifying a user. The data 408 may identify not only the at least one action to take, but may also identify a device or service to implement the action. For example, if the at least one action to take was an action to reroute a UAV flight plan, the data 408 may identify the UAV as the device to take the at least one action. In another example, if the at least one action were a request to send a text message, the data 408 could identify a service offering texting capabilities for sending the text message. In another example, the action may be taken locally. For instance, if the computing device includes texting capability, the data 408 may indicate that the computing device 402 should send the text message. Thus, the data 408 representing the at least one action to take may identify that the action be taken locally or remotely and give an identification of a device or service to take the action. The data 408 representing at least one action to take may be information describing the action to take, or the data 408 may be a reference to a data store storing information about actions to take.

In some examples, the data 406 representing the identification of the object may be sent to another computing device for detection of the object. For example, as described previously, a computing device 402 such as control device 120 of FIG. 1 may send the data 406 representing the identification of the object to a UAV, such as UAV 102 over network 118. The UAV 102 may include computer instructions implemented by processor 104 for detecting the object based on the data 406. Thus, the object detection can be performed at the UAV rather than at the computing device 402. In such examples, the UAV may send data indicating that the object was detected to the computing device 402 when the object is detected.

In other examples, the UAV 102 may not perform any object detection, and instead may forwards a stream of sensor data to the computing device 402, such as control device 120, which can then analyze the stream of data to detect the object. For example, if the UAV sends a data stream including a video feed to the computing device 402, the computing device 402 can analyze the video feed locally to detect an object based on the data representing the identification of the object. The identification of the object may be done using convention techniques as known in the art. Thus, in such examples the data related to the detection of the object can include the stream of data from the UAV.

In some examples, the data 406 related to the identification of the object may be sent to a remote computer such as server 140. Thus, the server 140 may receive the stream of data from the UAV or the computing device 402 and analyze the stream of data to detect the object using conventional techniques. The server 140 may then send data indicating the object was detected to the computing device 402.

As described previously, the computing device 402 receives 410 the data 412 related to the detection of the object. Depending on where the actual object detection takes place, the data 412 related to the detection of the object may be a stream of sensor data in instances where the detection is performed locally at the computing device 402, or the data 412 may indicate that the object was detected by a remote system such as UAV 102 or server 140. For example, if the object identification is taking place locally at the computing device 402, the data 412 related to the detection of an object may be a stream of data generated by a sensor of the UAV. The computing device 402 can then analyze the data 412 using conventional object detection techniques to detect the object in the stream of data. If the object detection is instead being performed remotely (e.g., at the UAV 102 or at the server 140), the data 412 related to the detection of the object that is received by the computing device 402 may be a formatted data type that indicates that the object was detected. For example, the data 412 related to the detection of the object may include a picture of the object and information about where it was detected. In still other examples the detection of the object may be split between multiple device such that a limited stream of data is sent to a computing device for detection of the object. For example, the UAV 102 may send a stream of sensor data only when the UAV 102 might be detecting something of interest, and that stream of data may then be analyzed by a separate computing device to detect the object. For example, the UAV 102 may perform high speed object detection having a relatively low level of confidence and send data only after an object has been \ potentially detected. Or, in some examples, the UAV may send data after being triggered by another sensor. For example, if the UAV is looking for an object that is hotter than its surroundings, it may send the data only after a thermal sensor detects an elevated temperature.

In response the object being detected, either locally at the computing device 402 or at a remote device, the computing device 402 initiates 414 performance of the at least one action. The at least one action may be performed locally, or the at least one action may be performed at a separate device. If the at least one action is performed at a separate device, initiating the at least one action can include sending a message to the separate device to perform the at least one action. In some examples, the at least one action may include multiple actions that may involve multiple devices. In such instances initiating performance of the at least one action may include sending a message to each separate device to perform an action identified in the data 408 referencing at least one action to perform. The computing device initiate the performance of the at least one action in response to the object being detected by the local computing device through analyzing the data related to the detection of the object, or the computing device may take the at least one action in response to receiving data informing the computing device that the object was detected by another device.

Initiating the at least one action is based on the data describing at least one action received by the computing device 402. In some instances, the at least one action may not be taken directly by the computing device 402 but may instead be initiated by the computing device 402 by sending an instruction to a separate device. For example, if the action to take were to send a text message and the computing device 402 did not have texting capability, the computing device 402 can initiate the action by sending an instruction to a device having text capabilities to send a text message.

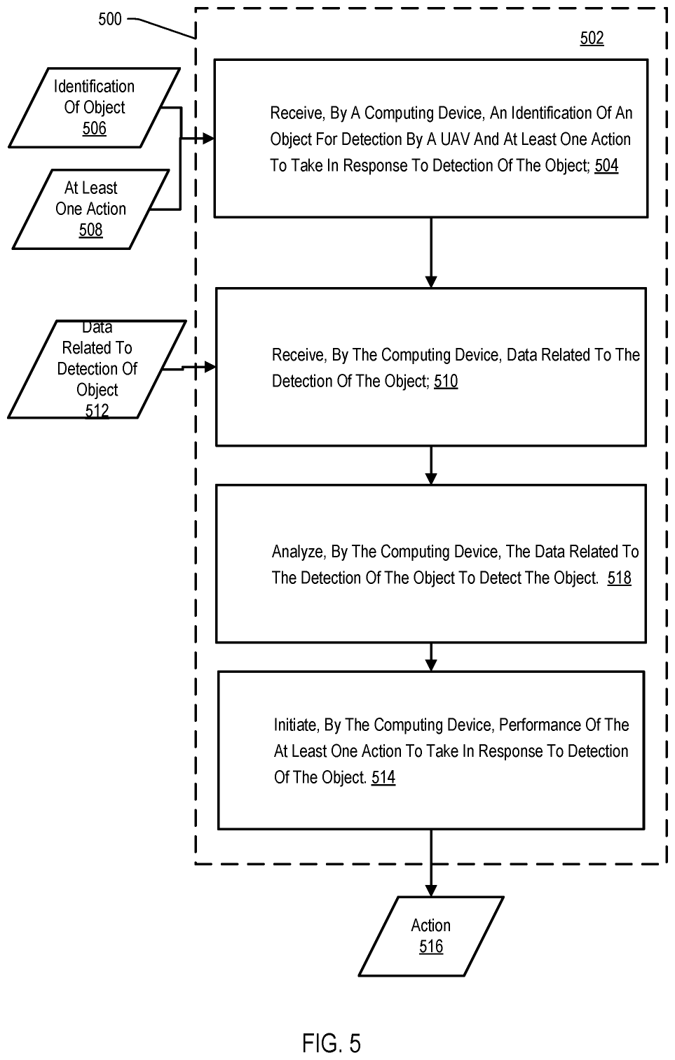

For further explanation, FIG. 5 sets forth a flow chart illustrating an exemplary method 500 for UAV response to object detection in accordance with embodiments of the invention. The method of FIG. 5 similar to the method of FIG. 4 in that it is implemented by a computing device 502 that provides an interface between a UAV user and a UAV. For example, in some embodiments the computing device 502 of FIG. 5 can be the control device 120 of FIGS. 1 and 2, the server 140 of FIGS. 1 and 2, or the distributed computing network 151 of FIGS. 1 and 2. The UAV user can be a UAV pilot or other user of the computing device 502. The computing device 502 can be a computing device that is local to a user, such as control device 120 of FIG. 1, a computing device that is local to a UAV, such as UAV 102 of FIG. 1, or a device that is remote to both the user and the UAV, such as a server 140. The UAV can be the UAV 102 of FIGS. 1 and 2. Additionally, the method 500 of FIG. 5 is similar to the method 400 of FIG. 4 in that the method 500 includes receiving 504 data 506, by the computing device 502, with the data 506 representing an identification of an object for detection by a UAV and receiving 504 data 508 representing at least one action to take in response to detecting the object, receiving 510 data 512 related to the detection of the object, and performing 514 the at least one action 516 responsive to receiving the data 512 related to the detection of the object. However, the method 500 of FIG. 5 differs from the method 400 of FIG. 4 in that the method 500 of FIG. 5 further includes analyzing 518, by the computing device 502, the data 512 related to the detection of the object to detect the object.

In some examples, a UAV such as UAV 102 of FIG. 1, can send data 512 related to the detection of the object in the form of a raw stream of sensor data to the computing device 502. For example, the raw stream of sensor data can be a video stream, location data, temperature data, weather data, radar data, or other information suitable for detecting an object. The computing device 502 can then process the raw stream to detect the object.

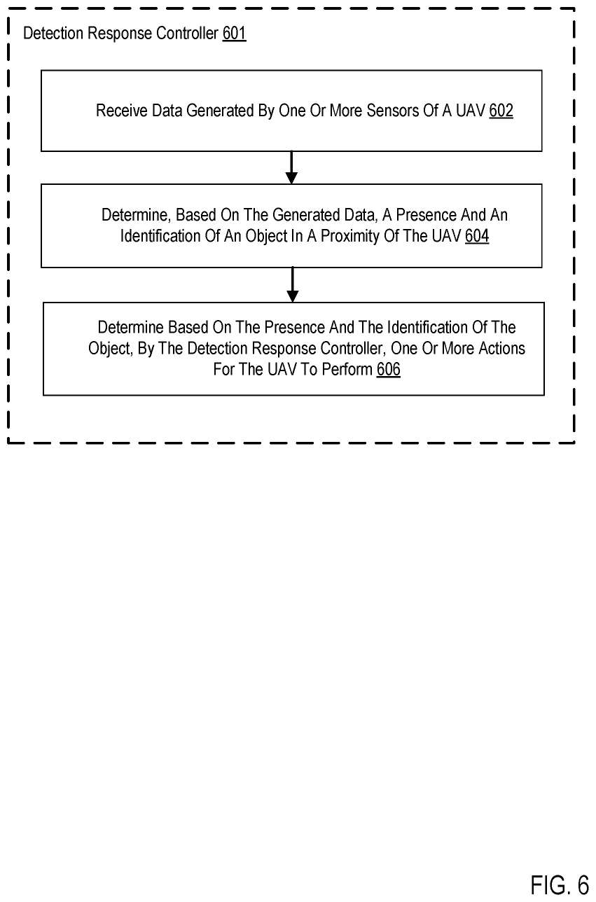

For further explanation, FIG. 6 sets forth a flow chart illustrating an exemplary method for UAV response to object detection in accordance with embodiments of the invention. The method of FIG. 6 includes receiving 602, by a detection response controller 601, data generated by one or more sensors of a UAV. Examples of sensors may include cameras, microphones, GPS, thermal sensors, and others as will occur to those of skill in the art. The detection response controller 601 of FIG. 6 may be part of a UAV or alternatively may be part of a computing device that is remote to the UAV. Receiving 602, by a detection response controller 601, data generated by one or more sensors of a UAV may be carried out by receiving the sensor data directly from the sensor; receiving the sensor data from memory within the UAV or remote computing device; and receiving the sensor data from a device remote to the detection response controller, via a communication network.

The method of FIG. 6 also includes determining 604 based on the generated data, by the detection response controller 601, a presence and an identification of an object in a proximity of the UAV. A proximity of a UAV may be a physical range of one or more sensors of the UAV. A presence of an object may be a positive indication of an object. An identification of an object may be an indication of a particular type of object; or a parameter/characteristic of an object. Determining 604 based on the generated data, by the detection response controller 601, a presence and an identification of an object in a proximity of the UAV may be carried out by receiving from a user, data that identifies the object or receiving from another computing device, data that identifies the object. Alternatively, the detection response controller may include object recognition and detection programs and processes that are capable of detecting and identifying an object without intervention from a user or another device. In this example, the recognition and detection programs and processes may search for specific parameters and characteristics within the sensor data; and determine that a match of the sensor data to particular parameters or characteristics represents a detection and an identification of a specific object.

The object for detection by the UAV can be any object that a user desires to be detected by the UAV. For example, the object can be a person, an animal, a vehicle, a structure, a liquid, a plant, smoke, or a fire. In some examples, the object can detect a general object type such as any person, animal, vehicle, structure, liquid, plant, smoke, or fire, or it can be a specific object limited to a particular set or individual item. For example, the object could be a particular person. In such instances, the object may be identified using techniques such as facial recognition or other identification techniques. In other examples, the object to be detected can be a set of persons, such as persons having a particular characteristic. For example, the object to be detected could be people wearing a certain color, people of a certain height, or people matching a certain description. In still other examples, the object to be detected can be limited to an object in a particular location or in association with another object. For example, a UAV inspecting a pipeline may not react to the detection of a liquid unless the liquid is adjacent to a pipeline, or a person may be ignored unless they are within a specific geographic boundary. In another example, a characteristic may include patterns for recognition such as a bar code or quick response (QR) code, an object temperature, a movement characteristic such as smooth or intermittent, a gait style, object emissions, sound patterns, or other characteristics. Determining the presence and the identification of a particular object may rely upon a plurality of sensors. For example, the sensor data may include information from a camera for a visual identification, a microphone for audio detection, a GPS system for identifying location, and/or a thermal sensor for identifying a temperature.

In addition, the method of FIG. 6 includes determining 606 based on the presence and the identification of the object, by the detection response controller 601, one or more actions for the UAV to perform. Examples of actions include but are not limited to sending an alert, sending a text message, sending an email message, altering a flight plan, increasing a counter, and notifying a user. Determining 606 based on the presence and the identification of the object, by the detection response controller 601, one or more actions for the UAV to perform may be carried out by receiving a selection of the one or more actions from a user; receiving a selection of the one or more actions from a remote computing device; and utilizing an index to identify a predetermined correlation between the determined presence/identification of an object and one or more actions.

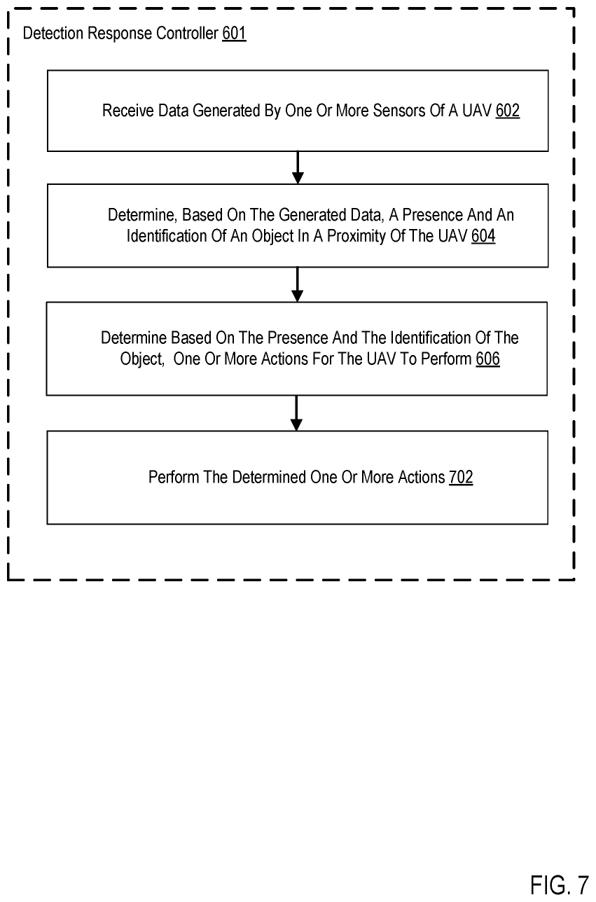

For further explanation, FIG. 7 sets forth a flow chart illustrating an exemplary method for UAV response to object detection in accordance with embodiments of the invention. The method of FIG. 7 is similar to the method of FIG. 6 in that the method of FIG. 7 also includes receiving 602, by a detection response controller 601, data generated by one or more sensors of a UAV; determining 604 based on the generated data, by the detection response controller 601, a presence and an identification of an object in a proximity of the UAV; and determining 606 based on the presence and the identification of the object, by the detection response controller 601, one or more actions for the UAV to perform.

In the method of FIG. 7, however, the detection response controller is located within the UAV. In this example embodiment, the method of FIG. 7 also includes performing 702, by the detection response controller 701, the determined one or more actions. Performing 702, by the detection response controller 701, the determined one or more actions may be carried out by altering a flight plan; executing a search of an area; changing a flight speed; activating one or more sensors, instruments, components, or devices of the UAV. For example, the UAV may broadcast a message over a speaker; turn on a microphone; hover at a particular height; and other actions as will occur to those of skill in the art.

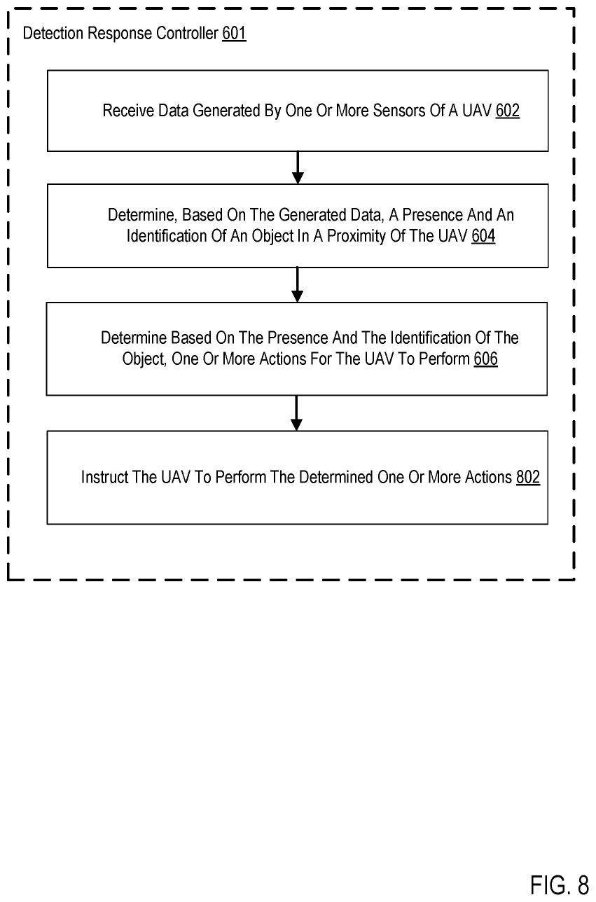

For further explanation, FIG. 8 sets forth a flow chart illustrating an exemplary method for UAV response to object detection in accordance with embodiments of the invention. The method of FIG. 8 is similar to the method of FIG. 6 in that the method of FIG. 8 also includes receiving 602, by a detection response controller 601, data generated by one or more sensors of a UAV; determining 604 based on the generated data, by the detection response controller 601, a presence and an identification of an object in a proximity of the UAV; and determining 606 based on the presence and the identification of the object, by the detection response controller 601, one or more actions for the UAV to perform.

In the method of FIG. 8, however, the detection response controller is located within a computing device (e.g., the control device 120 of FIG. 1 and the server 140 of FIG. 1) that is remote to the UAV. In this example embodiment, the method of FIG. 8 also includes instructing 802, by the detection response controller 601, the UAV to perform the determined one or more actions. Instructing 802, by the detection response controller 601, the UAV to perform the determined one or more actions may be carried out by sending a message to the UAV to perform the determined one or more actions. In response to receiving the message, the UAV may perform the one or more actions.

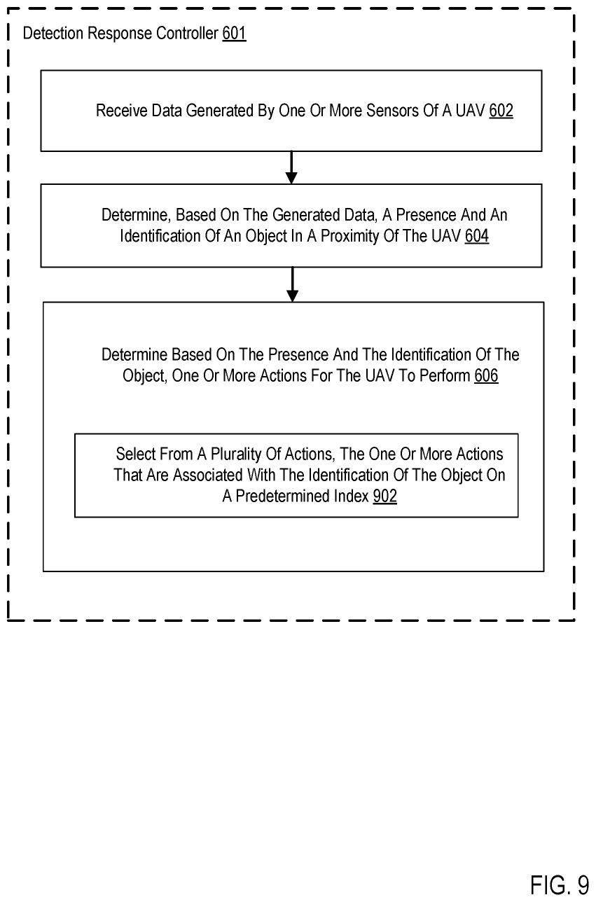

For further explanation, FIG. 9 sets forth a flow chart illustrating an exemplary method for UAV response to object detection in accordance with embodiments of the invention. The method of FIG. 9 is similar to the method of FIG. 6 in that the method of FIG. 9 also includes receiving 602, by a detection response controller 601, data generated by one or more sensors of a UAV; determining 604 based on the generated data, by the detection response controller 601, a presence and an identification of an object in a proximity of the UAV; and determining 606 based on the presence and the identification of the object, by the detection response controller 601, one or more actions for the UAV to perform.

In the method of FIG. 9, however, determining 606 based on the presence and the identification of the object, by the detection response controller 601, one or more actions for the UAV to perform includes selecting 902 from a plurality of actions, the one or more actions that are associated with the identification of the object on a predetermined index. A predetermined index may list an identification of an object with a corresponding identification of one or more actions. For example, an identification of a person may have a corresponding one or more actions of activating a broadcast message; transmitting a response to a control device; turning on a microphone. As another example, an identification of a fire may have a corresponding one or more actions of sending a text message; activating a camera; and transmitting images. Selecting 902 from a plurality of actions, the one or more actions that are associated with the identification of the object on a predetermined index may be carried out by searching the predetermined index; and identifying a corresponding match.

For example, the detection response controller may include a predetermined index that matches identifications of objects with a corresponding set of one or more actions. In this example, the detection response controller may be capable of selecting the one or more actions for the UAV to perform without user intervention or intervention from a remote computing device or user.

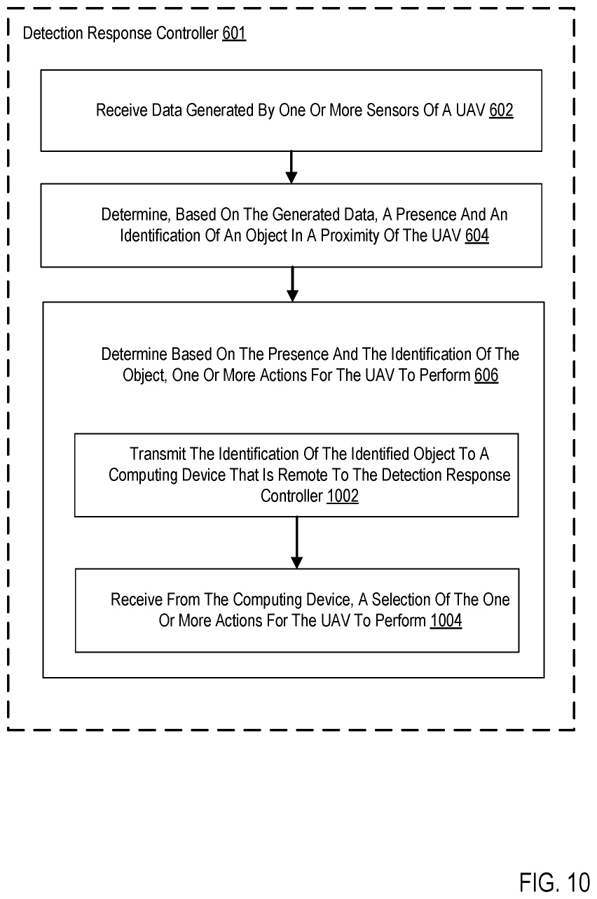

For further explanation, FIG. 10 sets forth a flow chart illustrating an exemplary method for UAV response to object detection in accordance with embodiments of the invention. The method of FIG. 10 is similar to the method of FIG. 6 in that the method of FIG. 10 also includes receiving 602, by a detection response controller 601, data generated by one or more sensors of a UAV; determining 604 based on the generated data, by the detection response controller 601, a presence and an identification of an object in a proximity of the UAV; and determining 606 based on the presence and the identification of the object, by the detection response controller 601, one or more actions for the UAV to perform.

In the method of FIG. 10, however, determining 606 based on the presence and the identification of the object, by the detection response controller 601, one or more actions for the UAV to perform includes transmitting 1002 the identification of the identified object to a computing device that is remote to the detection response controller. Transmitting 1002 the identification of the identified object to a computing device that is remote to the detection response controller may be carried out by sending as a message the identification of the identified object.

In addition, in the method of FIG. 10, determining 606 based on the presence and the identification of the object, by the detection response controller 601, one or more actions for the UAV to perform includes receiving 1004 from the computing device, a selection of the one or more actions for the UAV to perform. Receiving 1004 from the computing device, a selection of the one or more actions for the UAV to perform may be carried out by receiving a message that identifies the one or more actions for the UAV to perform in response to determining the presence and the identification of the object.

For example, the detection response controller may provide a remote computing device with the identification of the object and the remote computing device may determine the one or more actions for the detection response controller. In this example, the remote computing device may generate a user interface for receiving the selection from a user or alternatively, may include a predetermined index for selecting the one or more actions based on a match within the index to an identification of the object. Continuing with this example, the remote computing device may provide the selection of the one or more actions to the detection response controller.

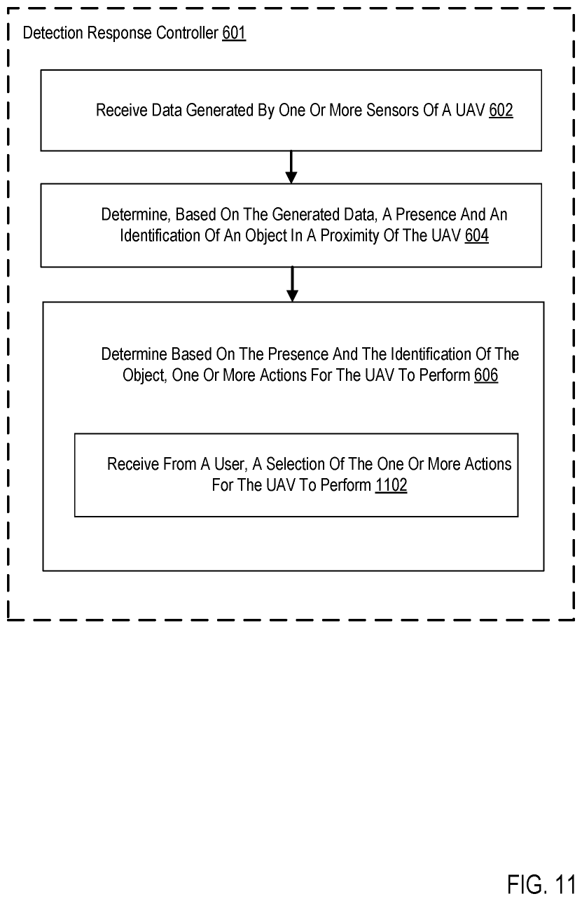

For further explanation, FIG. 11 sets forth a flow chart illustrating an exemplary method for UAV response to object detection in accordance with embodiments of the invention. The method of FIG. 11 is similar to the method of FIG. 6 in that the method of FIG. 11 also includes receiving 602, by a detection response controller 601, data generated by one or more sensors of a UAV; determining 604 based on the generated data, by the detection response controller 601, a presence and an identification of an object in a proximity of the UAV; and determining 606 based on the presence and the identification of the object, by the detection response controller 601, one or more actions for the UAV to perform.

In the method of FIG. 11, however, determining 606 based on the presence and the identification of the object, by the detection response controller 601, one or more actions for the UAV to perform includes receiving 1102 from a user, a selection of the one or more actions for the UAV to perform. Receiving 1102 from a user, a selection of the one or more actions for the UAV to perform may be carried out by generating a user interface that displays a list of actions to a user; and receiving a selection of one or more actions via the user interface.

In addition, determining 606 based on the presence and the identification of the object, by the detection response controller 601, one or more actions for the UAV to perform also includes using the user input to select the one or more actions for the UAV to perform. For example, the user interface may prompt a user for at least one action to perform when the object is detected. In some examples, the user interface may provide the user with a selection box of options for selecting at least one action to perform.

Exemplary embodiments of the present invention are described largely in the context of a fully functional computer system for utilizing an unmanned aerial vehicle to perform an action in response to detection of an object. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A method of unmanned aerial vehicle (UAV) response to object detection, the method comprising: receiving, by a detection response controller, data generated by one or more sensors of a UAV; determining based on the generated data, by the detection response controller, a presence and an identification of an object in a proximity of the UAV; and determining based on the presence and the identification of the object, by the detection response controller, one or more actions for the UAV to perform.

2. The method of statement 1 wherein the detection response controller is located within the UAV; and the method further comprising: performing, by the detection response controller, the determined one or more actions.

3. The method of any of statements 1 and 2 wherein the detection response controller is located within a computing device that is remote to the UAV; and the method further comprising: instructing, by the detection response controller, the UAV to perform the determined one or more actions.

4. The method of any of statements 1-3 wherein determining based on the presence and the identification of the object, by the detection response controller, one or more actions for the UAV to perform includes: selecting from a plurality of actions, the one or more actions that are associated with the identification of the object on a predetermined index.

5. The method of any of statements 1-4 wherein determining based on the presence and the identification of the object, by the detection response controller, one or more actions for the UAV to perform includes: transmitting the identification of the identified object to a computing device that is remote to the detection response controller; and receiving from the computing device, a selection of the one or more actions for the UAV to perform.

6. The method of any of statements 1-5 wherein determining based on the presence and the identification of the object, by the detection response controller, one or more actions for the UAV to perform includes: receiving from a user, a selection of the one or more actions for the UAV to perform.

7. The method of any of statements 1-6, wherein the one or more actions include at least one of: sending an alert, sending a text message, sending an email message, altering a flight plan, increasing a counter, and notifying a user.

8. The method of any of statements 1-7, wherein the object comprises at least one of a person, an animal, a vehicle, a structure, a liquid, a plant, smoke, or a fire.

9. An apparatus for unmanned aerial vehicle (UAV) response to object detection, the apparatus comprising: a processor; and a memory storing instructions that when executed by the processor cause the apparatus to carry out operations of: receiving, by a detection response controller, data generated by one or more sensors of a UAV; determining based on the generated data, by the detection response controller, a presence and an identification of an object in a proximity of the UAV; and determining based on the presence and the identification of the object, by the detection response controller, one or more actions for the UAV to perform.

10. The apparatus of statement 9, wherein the detection response controller is located within the UAV; and the memory further comprising instructions that when executed by the processor cause the apparatus to carry out the operations of: performing, by the detection response controller, the determined one or more actions.

11. The apparatus of any of statements 9-10, wherein the detection response controller is located within a computing device that is remote to the UAV; and the memory further comprising instructions that when executed by the processor cause the apparatus to carry out the operations of: instructing, by the detection response controller, the UAV to perform the determined one or more actions.

12. The apparatus of any of statements 9-11, wherein determining based on the presence and the identification of the object, by the detection response controller, one or more actions for the UAV to perform includes: selecting from a plurality of actions, the one or more actions that are associated with the identification of the object on a predetermined index.

13. The apparatus of any of statements 9-12, wherein determining based on the presence and the identification of the object, by the detection response controller, one or more actions for the UAV to perform includes: transmitting the identification of the identified object to a computing device that is remote to the detection response controller; and receiving from the computing device, a selection of the one or more actions for the UAV to perform.

14. The apparatus of any of statements 9-13, wherein determining based on the presence and the identification of the object, by the detection response controller, one or more actions for the UAV to perform includes: receiving from a user, a selection of the one or more actions for the UAV to perform.

15. A computer program product for unmanned aerial vehicle (UAV) response to object detection, the computer program product disposed upon a non-transitory computer readable medium, the computer program product comprising computer program instructions that, when executed, cause a computer to carry out the operations of: receiving, by a detection response controller, data generated by one or more sensors of a UAV; determining based on the generated data, by the detection response controller, a presence and an identification of an object in a proximity of the UAV; and determining based on the presence and the identification of the object, by the detection response controller, one or more actions for the UAV to perform.

16. The computer program product of statement 15, wherein the detection response controller is located within the UAV; and the computer program product further comprising instructions that when executed by the computer cause the computer to carry out the operations of: performing, by the detection response controller, the determined one or more actions.

17. The computer program product of any of statements 15-16, wherein the detection response controller is located within a computing device that is remote to the UAV; and the computer program product further comprising instructions that when executed by the computer cause the computer to carry out the operations of: instructing, by the detection response controller, the UAV to perform the determined one or more actions.

18. The computer program product of any of statements 15-17, wherein determining based on the presence and the identification of the object, by the detection response controller, one or more actions for the UAV to perform includes: selecting from a plurality of actions, the one or more actions that are associated with the identification of the object on a predetermined index.

19. The computer program product of any of statements 15-18, wherein determining based on the presence and the identification of the object, by the detection response controller, one or more actions for the UAV to perform includes: transmitting the identification of the identified object to a computing device that is remote to the detection response controller; and receiving from the computing device, a selection of the one or more actions for the UAV to perform.

20. The computer program product of any of statements 15-19, wherein determining based on the presence and the identification of the object, by the detection response controller, one or more actions for the UAV to perform includes: receiving from a user, a selection of the one or more actions for the UAV to perform.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of unmanned aerial vehicle (UAV) response to object detection, the method comprising:
receiving, by a detection response controller, data generated by one or more sensors of a UAV;
determining based on the generated data, by the detection response controller, a presence and an identification of an object in a proximity of the UAV; and
determining based on the presence and the identification of the object, by the detection response controller, one or more actions for the UAV to perform.

2. The method of claim 1 wherein the detection response controller is located within the UAV; and the method further comprising: performing, by the detection response controller, the determined one or more actions.

3. The method of claim 1 wherein the detection response controller is located within a computing device that is remote to the UAV; and the method further comprising: instructing, by the detection response controller, the UAV to perform the determined one or more actions.

4. The method of claim 1 wherein determining based on the presence and the identification of the object, by the detection response controller, one or more actions for the UAV to perform includes:
selecting from a plurality of actions, the one or more actions that are associated with the identification of the object on a predetermined index.

5. The method of claim 1 wherein determining based on the presence and the identification of the object, by the detection response controller, one or more actions for the UAV to perform includes:
transmitting the identification of the identified object to a computing device that is remote to the detection response controller; and
receiving from the computing device, a selection of the one or more actions for the UAV to perform.

6. The method of claim 1 wherein determining based on the presence and the identification of the object, by the detection response controller, one or more actions for the UAV to perform includes:
receiving from a user, a selection of the one or more actions for the UAV to perform.

7. The method of claim 1, wherein the one or more actions include at least one of: sending an alert, sending a text message, sending an email message, altering a flight plan, increasing a counter, and notifying a user.

8. The method of claim 1, wherein the object comprises at least one of a person, an animal, a vehicle, a structure, a liquid, a plant, smoke, or a fire.

9. An apparatus for unmanned aerial vehicle (UAV) response to object detection, the apparatus comprising:
a processor; and
a memory storing instructions that when executed by the processor cause the apparatus to carry out operations of:
receiving, by a detection response controller, data generated by one or more sensors of a UAV;
determining based on the generated data, by the detection response controller, a presence and an identification of an object in a proximity of the UAV; and
determining based on the presence and the identification of the object, by the detection response controller, one or more actions for the UAV to perform.

10. The apparatus of claim 9, wherein the detection response controller is located within the UAV; and the memory further comprising instructions that when executed by the processor cause the apparatus to carry out the operations of: performing, by the detection response controller, the determined one or more actions.

11. The apparatus of claim 9, wherein the detection response controller is located within a computing device that is remote to the UAV; and the memory further comprising instructions that when executed by the processor cause the apparatus to carry out the operations of: instructing, by the detection response controller, the UAV to perform the determined one or more actions.

12. The apparatus of claim 9, wherein determining based on the presence and the identification of the object, by the detection response controller, one or more actions for the UAV to perform includes:
selecting from a plurality of actions, the one or more actions that are associated with the identification of the object on a predetermined index.

13. The apparatus of claim 9, wherein determining based on the presence and the identification of the object, by the detection response controller, one or more actions for the UAV to perform includes:
transmitting the identification of the identified object to a computing device that is remote to the detection response controller; and
receiving from the computing device, a selection of the one or more actions for the UAV to perform.

14. The apparatus of claim 9, wherein determining based on the presence and the identification of the object, by the detection response controller, one or more actions for the UAV to perform includes:
receiving from a user, a selection of the one or more actions for the UAV to perform.

15. A computer program product for unmanned aerial vehicle (UAV) response to object detection, the computer program product disposed upon a non-transitory computer readable medium, the computer program product comprising computer program instructions that, when executed, cause a computer to carry out the operations of:
receiving, by a detection response controller, data generated by one or more sensors of a UAV;
determining based on the generated data, by the detection response controller, a presence and an identification of an object in a proximity of the UAV; and
determining based on the presence and the identification of the object, by the detection response controller, one or more actions for the UAV to perform.

16. The computer program product of claim 15, wherein the detection response controller is located within the UAV; and the computer program product further comprising instructions that when executed by the computer cause the computer to carry out the operations of: performing, by the detection response controller, the determined one or more actions.

17. The computer program product of claim 15, wherein the detection response controller is located within a computing device that is remote to the UAV; and the computer program product further comprising instructions that when executed by the computer cause the computer to carry out the operations of: instructing, by the detection response controller, the UAV to perform the determined one or more actions.

18. The computer program product of claim 15, wherein determining based on the presence and the identification of the object, by the detection response controller, one or more actions for the UAV to perform includes:
selecting from a plurality of actions, the one or more actions that are associated with the identification of the object on a predetermined index.

19. The computer program product of claim 15, wherein determining based on the presence and the identification of the object, by the detection response controller, one or more actions for the UAV to perform includes:
transmitting the identification of the identified object to a computing device that is remote to the detection response controller; and
receiving from the computing device, a selection of the one or more actions for the UAV to perform.

20. The computer program product of claim 15, wherein determining based on the presence and the identification of the object, by the detection response controller, one or more actions for the UAV to perform includes:
receiving from a user, a selection of the one or more actions for the UAV to perform.
